(19) United States
(12) Patent Application Publication
(10) Pub. No.: US 2018/0154504 A1
(43) Pub. Date: Jun. 7, 2018

(54) ONE-WAY TORQUE ADJUSTABLE SCREWDRIVER

(71) Applicant: RE-DAI PRECISION TOOLS CO., LTD., TAICHUNG CITY (TW)

(72) Inventor: Yi Chiu CHOU, Taichung City (TW)

(21) Appl. No.: 15/484,167

(22) Filed: Apr. 11, 2017

(30) Foreign Application Priority Data
Dec. 7, 2016 (TW) 105218702

(51) Int. Cl. B25B 23/142; B25B 15/02

(52) U.S. Cl. CPC B25B 23/1427; B25B 15/02

(57) ABSTRACT

A one-way torque adjustable screwdriver comprises a body and a polygonal elastic member disposed inside the body. A torque transmission device and a torque adjusting device are mounted on two ends of the polygonal elastic member, respectively. A drive rod is connected to the torque transmission device. Driving the torque adjusting device to move can change a length of the polygonal elastic member, thus change an acting force of the polygonal elastic member exerted on the torque transmission device, change an output torque provided by the drive rod, and thus achieve the effect of easy operation.

### BACKGROUND OF THE INVENTION

### Field of the Invention

The invention relates to a technical field of a hand tool screwdriver, and more particularly to a screwdriver, which can be adjusted to generate a predetermined torque.

### Description of the Related Art

In a typical screwdriver, one end of a handle is fitted with an operating lever, and the handle and the operating lever are integrally connected together. In this manner, rotating the handle can rotate the operating lever synchronously, so that the operating level can tighten or loosen a screwing member. However, because the screwdriver provides no torque protection mechanism, the screwing member and a surface of a workpiece will be damaged if the operator applies the too large torque. Next, the operator may also incorrectly judge the screwing torque, and thus cause the insufficient screwing torque.

For the working content, in which the precise screwing torque is required, the above-mentioned screwdriver is obviously not proper. Taiwan Patent No. M510821 discloses a torque adjustable screwdriver comprising a handle, a hollow rod member, a torque adjusting mechanism, a collar, a clutch mechanism and a driving mechanism. The hollow rod member is connected to the handle to form a T-shaped structure. The torque adjusting mechanism is disposed inside the hollow rod member. The collar is integrally welded to the hollow rod member and has a working space communicating with the hollow rod member. An inner side of the working space has a meshing junction. The clutch mechanism is disposed inside the working space, and rests against the meshing junction. The driving mechanism is connected to and driven by the clutch mechanism. Although the above-mentioned patent provides the function of torque separation (idle) after the operation torque of the screwdriver reaches the predetermined torque, this patent uses multiple complicated mechanisms, and has the enlarged size due to the complicated mechanisms.

### SUMMARY OF THE INVENTION

An object of the invention is to provide a torque adjustable screwdriver capable of entering an idle state when an output torque of the screwdriver reaches a predetermined value in order to prevent the over-torque action from being caused on the screwing member.

Another object of the invention is to provide a torque adjustable screwdriver having the effect of simplifying the adjustment of an output torque by rotating a torque adjusting device.

To achieve the above-identified objects, the invention provides a torque adjustable screwdriver comprising a body and a polygonal elastic member disposed inside the body. A torque transmission device and a torque adjusting device are mounted on two ends of the polygonal elastic member, respectively. A drive rod is connected to the torque transmission device. Driving the torque adjusting device to move can change a length of the polygonal elastic member, thus change an acting force of the polygonal elastic member exerted on the torque transmission device, and thus change the output torque provided by the drive rod.

Further scope of the applicability of the present invention will become apparent from the detailed description given hereinafter. However, it should be understood that the detailed description and specific examples, while indicating preferred embodiments of the present invention, are given by way of illustration only, since various changes and modifications within the spirit and scope of the present invention will become apparent to those skilled in the art from this detailed description.

### BRIEF DESCRIPTION OF THE DRAWINGS

FIG. 1 is an exterior plane view showing the invention.

FIG. 2 is an exploded view showing the structure of the invention.

FIG. 3 is a schematic view showing the structure of the invention.

FIG. 4 is a schematic view showing a state where a torque value is changed by the invention.

FIG. 5 is an exploded view showing another embodiment of the invention.

FIG. 6 is a schematic view showing the structure of another embodiment of the invention.

### DETAILED DESCRIPTION OF THE INVENTION

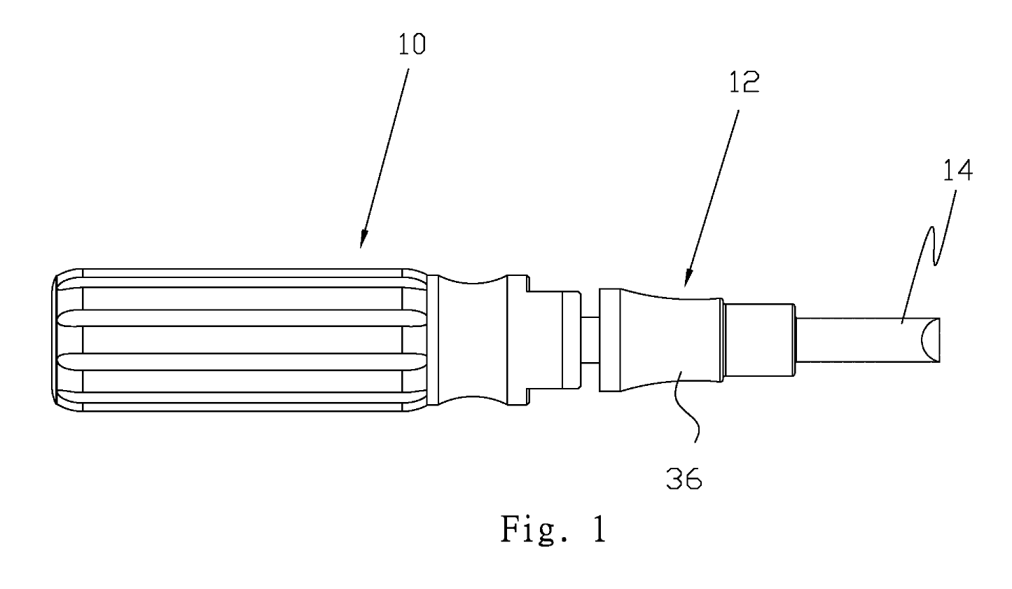

Referring to FIG. 1, a torque adjustable screwdriver of the invention has a body 10 having one end fitted with a drive rod 12. A screwdriver head 14 is fitted with one end of the drive rod 12. Rotating the body 10 can rotate the drive rod 12 and the screwdriver head 14 synchronously. When a screwing member (not shown) driven by the screwdriver head 14 has become a tightened state, and the output torque of the screwdriver transmitted through the screwdriver head 14 is not sufficient to drive the screwing member, the screwdriver head 14 and the drive rod 12 are not rotated, and the body 10 is rotated relatively to the drive rod 12 to form an idle state of the body 10.

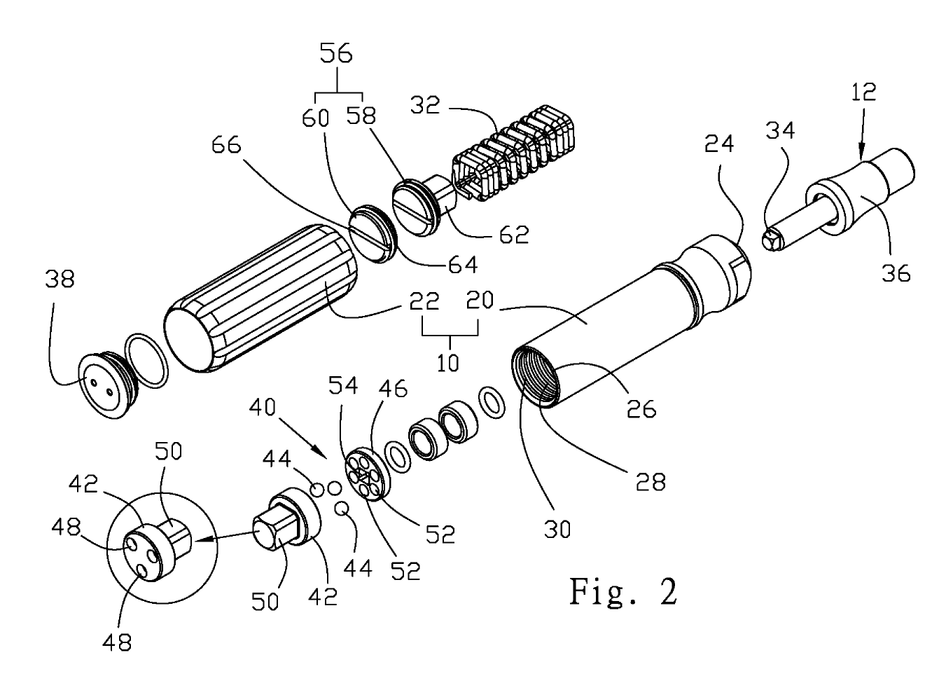

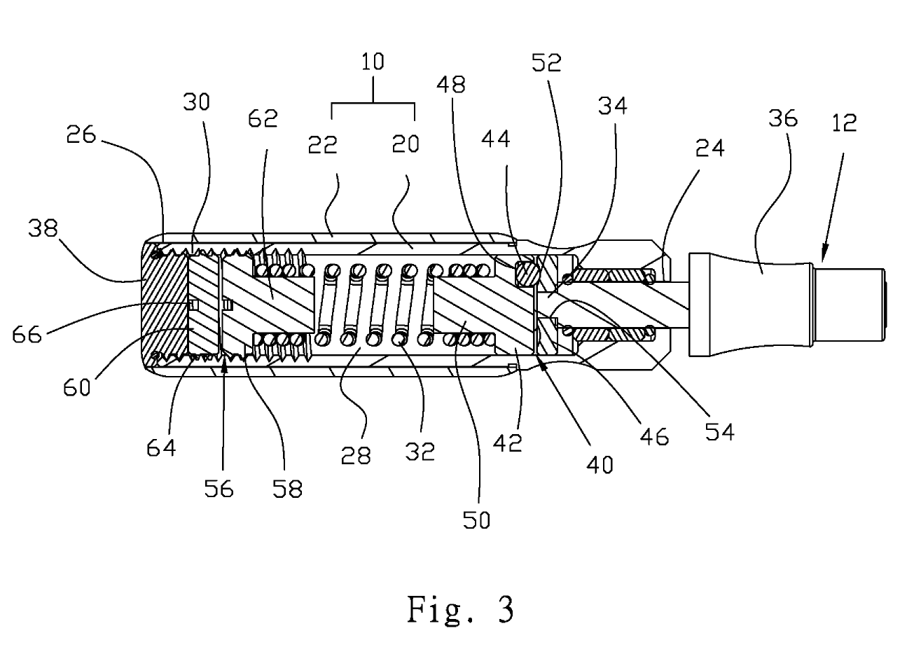

Referring to FIGS. 2 and 3, the body 10 is an inner sleeve 20 inserted into an axial inner portion of a handle 22. One end of the body 10 is a first opening end 24, and the other end of the body 10 is a second opening end 26. A chamber 28 is disposed inside the body 10. The chamber 28 connects the first opening end 24 to the second opening end 26. Furthermore, the chamber 28 is formed in an axial inner portion of the inner sleeve 20, and an inner wall surface of the chamber 28 of the body 10 has an internal thread 30 abutting upon the second opening end 26.

A polygonal elastic member 32 is mounted in the chamber 28 of the body 10. The polygonal elastic member 32 may be a quadrangular coil spring, and can be forced to deform elastically.

The drive rod 12 is mounted on the first opening end 24 of the body 10. Furthermore, a rod body 13 of the drive rod 12 has one end having a polygonal embedding portion 34, and the other end fitted with a fitting portion 36. Referring to FIG. 1, the fitting portion 36 is to be connected to the screwdriver head 14. A bottom cover 38 is mounted on the second opening end 26 of the body 10.

A torque transmission device 40 is mounted inside the chamber 28 of the body 10. The torque transmission device 40 is disposed between one end of the polygonal elastic member 32 and the drive rod 12. Furthermore, the torque transmission device 40 comprises a steel ball seat 42, a plurality of steel balls 44 and a torque disk 46. The steel ball seat 42 has one end having a plurality of bearing ball holes 48, and the other end being a polygonal embedding column 50. One surface of the torque disk 46 has a plurality of movable ball holes 52. The number of the movable ball holes 52 of the torque disk 46 is greater than the number of the steel balls 44.

The steel ball 44 is mounted inside the bearing ball hole 48. The torque disk 46 is stacked on each of the steel balls 44 to embed the steel ball 44 into the movable ball hole 52. The polygonal embedding column 50 of the steel ball seat 42 is embedded into the axial inner portion of the polygonal elastic member 32. One end of the drive rod 12 is embedded into the torque disk 46. More particularly, the torque disk 46 has a polygonal embedding hole 54, and the polygonal embedding portion 34 of the one end of the drive rod 12 is embedded into the polygonal embedding hole 54.

According to the contents disclosed hereinabove, the drive rod 12 can be fitted with a fastener, such as a C-ring, for restricting the drive rod 12 from separating from the torque disk 46. In addition, the rod body 13 of the drive rod 12 and the torque disk 46 may be integrally formed into one piece, and the fitting portion 36 is assembled on the axial portion of the rod body 13.

A torque adjusting device 56 is mounted inside the chamber 28 of the body 10. The torque adjusting device 56 is disposed between the polygonal elastic member 32 and the bottom cover 38.

Furthermore, the torque adjusting device 56 comprises a torque push member 58 and a torque adjusting plate 60. One end of the torque push member 58 is a polygonal push column 62, and an outer periphery of the torque push member 58 has a threaded portion 59. The torque adjusting plate 60 is adhered to the one end of the torque push member 58. The polygonal push column 62 of the torque push member 58 is embedded into the axial inner portion of the polygonal elastic member 32, and the threaded portion 59 meshes with the internal thread 30 of the inner wall surface of the chamber 28. The periphery of the torque adjusting plate 60 has an external thread 64 meshing with the internal thread 30 of the inner wall surface of the chamber 28. Next, one side surface of the torque adjusting plate 60 has a drive slot 66.

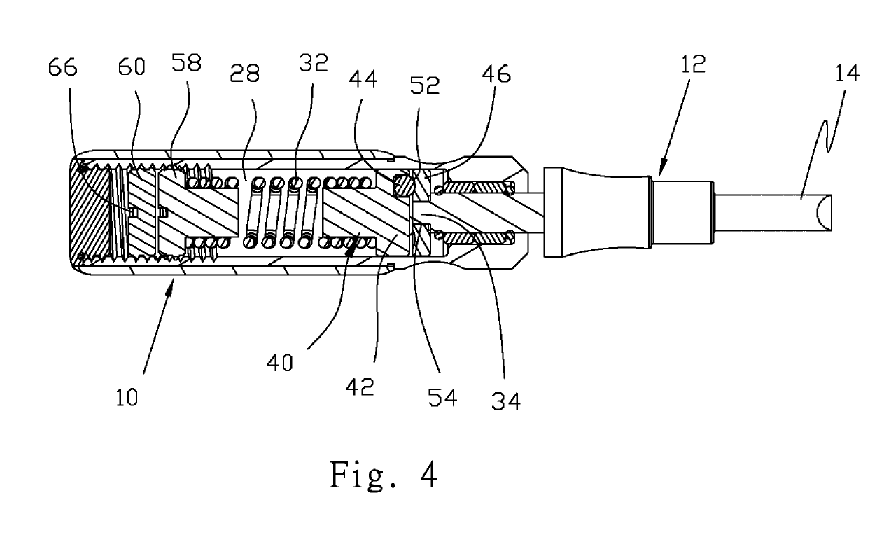

Referring to FIG. 4, the user can utilize a tool to rotate the torque push member 58 firstly to change the deformation amount of the polygonal elastic member 32, and then embed the tool into the drive slot 66 of the torque adjusting plate 60 and move the torque adjusting plate 60 to rest against the torque push member 58 by way of rotation. In this manner, the output torque that can be provided by the drive rod 12 can be changed by changing the acting force of the polygonal elastic member 32 exerted on the torque transmission device 40. In addition, the relative movement between the torque push member 58 and the torque adjusting plate 60 cannot be caused due to the reaction force of the torque by the structure form, in which the torque push member 58 and the torque adjusting plate 60 mesh with the internal thread 30 of the inner wall surface of the chamber 28, so that the polygonal elastic member 32 can keep the predetermined elastic acting force.

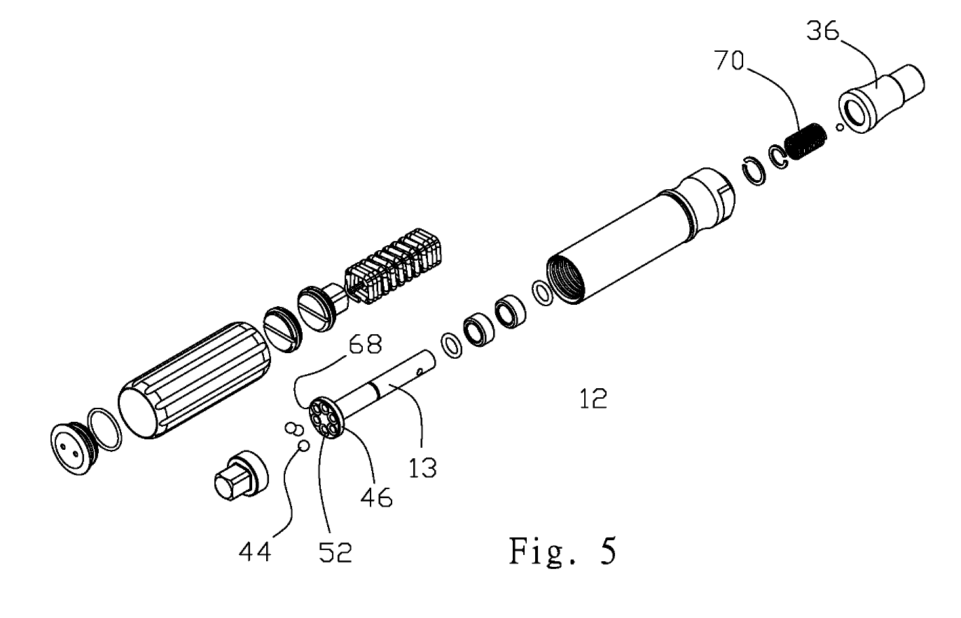

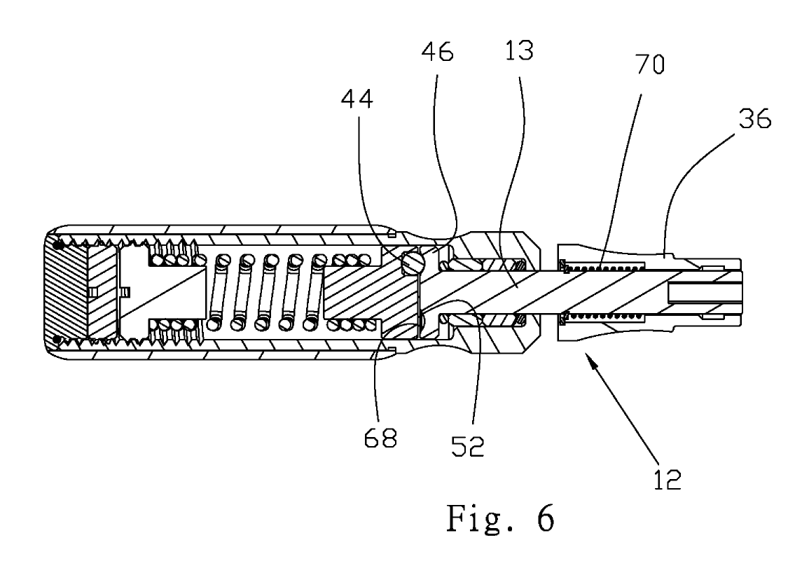

Referring to FIGS. 5 and 6, the torque disk 46 and one end of the rod body 13 of the drive rod 12 are integrally formed into one piece in another embodiment. Furthermore, an arced surface 68 is formed on the periphery of the movable ball hole 52 on one side of the torque disk 46. A spring 70 is disposed inside the fitting portion 36. The rod body 13 of the drive rod 12 passes through the spring 70. More particularly, an elastic relative movement between the fitting portion 36 and the rod body 13 can be generated.

When the torque of the screwdriver head 14 corresponding to the screwing member (not shown) reaches the predetermined value and the user again rotates the body 10, the drive rod 12 cannot be rotated. The torque disk 46 cannot be rotated because the torque disk 46 of the torque transmission device 40 and the drive rod 12 are embedded and combined with each other through the polygonal embedding hole 54 and the polygonal embedding portion 34. Further, the combination of the steel ball seat 42 and each steel ball 44 can receive the torque, exerted on the body 10, to rotate. More particularly, each steel ball 44 can be moved to change the position thereof to each movable ball hole 52 of the torque disk 46. In other words, when the predetermined torque value is reached, the body 10 can enter the idle state to achieve the effect of providing the predetermined torque.

More particularly, according to the structures shown in FIGS. 5 and 6, when the steel ball 44 jumps and changes it position relatively to the torque disk 46, the steel ball 44 can be smoothly moved along the curvature of the arced surface 68, so as to reduce the vibration generated when the steel ball 44 moves and changes its position.

While the present invention has been described by way of examples and in terms of preferred embodiments, it is to be understood that the present invention is not limited thereto. To the contrary, it is intended to cover various modifications. Therefore, the scope of the appended claims should be accorded the broadest interpretation so as to encompass all such modifications.

1. A one-way torque adjustable screwdriver to be connected to a screwdriver head and transmitting an output torque, the one-way torque adjustable screwdriver comprising:
a body having one end being a first opening end, and the other end being a second opening end, wherein a chamber is disposed inside the body and connects the first opening end to the second opening end;
a polygonal elastic member, which is mounted inside the chamber of the body, wherein the polygonal elastic member can be forced to deform elastically;
a drive rod, which is mounted on the first opening end of the body and to be connected to the screwdriver head;
a bottom cover mounted on the second opening end of the body;
a torque transmission device, which is mounted inside the chamber of the body and disposed between one end of the polygonal elastic member and the drive rod; and
a torque adjusting device, which is mounted inside the chamber of the body and disposed between the polygonal elastic member and the bottom cover;
wherein one end of the torque transmission device is embedded into the polygonal elastic member, and the other end of the torque transmission device is connected to the drive rod; one end of the torque adjusting device is embedded into the polygonal elastic member; driving the torque adjusting device can change a deformation amount of the polygonal elastic member, thus change an acting force of the polygonal elastic member exerted on the torque transmission device, and thus change the output torque provided by the drive rod;
wherein the torque adjusting device comprises a torque push member and a torque adjusting plate; both the torque push member and the torque adjusting plate are received in the chamber of the body, and the torque push member is between the torque adjusting plate and the polygonal elastic member; an inner wall surface of the chamber of the body has an internal thread, a periphery of the torque adjusting plate has an external thread, an outer periphery of the torque push member has a threaded portion, and the threaded portion of the torque push member and the external thread of the torque adjusting plate mesh with the internal thread; the torque push member has a polygonal push column engaging the polygonal elastic member; the torque push member rests against the torque adjusting plate;
whereby while the polygonal elastic member is twisted, the torque push member is adapted to be turned and moved in the chamber of the body; since the torque push member rests against the torque adjusting plate, the torque push member is unable to turn and move that makes the polygonal elastic member unable to turn.

2. The one-way torque adjustable screwdriver according to claim 1, wherein the torque transmission device comprises a steel ball seat, a plurality of steel balls and a torque disk, one end of the steel ball seat has a plurality of bearing ball holes, the other end of the steel ball seat is a polygonal embedding column, the steel ball is mounted inside the bearing ball hole, one surface of the torque disk has a plurality of movable ball holes, the torque disk is stacked on each of the steel balls, and the steel ball is embedded into the movable ball hole; and the polygonal embedding column of the steel ball seat is embedded into the polygonal elastic member, and one end of the drive rod is embedded into the torque disk.

3. The one-way torque adjustable screwdriver according to claim 2, wherein a periphery of each of the movable ball holes of the one surface of the torque disk is formed with an arced surface.

4. The one-way torque adjustable screwdriver according to claim 2, wherein the number of the movable ball holes of the torque disk is greater than the number of the steel balls.

5. The one-way torque adjustable screwdriver according to claim 2, wherein the torque disk has a polygonal embedding hole, the one end of the drive rod has a polygonal embedding portion, and the polygonal embedding portion is embedded into the polygonal embedding hole.

6. (canceled)

7. (canceled)

8. The one-way torque adjustable screwdriver according to claim 1, wherein the body is an inner sleeve inserted into an axial inner portion of a handle, and the chamber is formed in an axial inner portion of the inner sleeve.
